(19) United States
(12) Patent Application Publication
(10) Pub. No.: US 2015/0370399 A1
(43) Pub. Date: Dec. 24, 2015

(54) MOBILE TERMINAL AND METHOD OF CONTROLLING THE SAME

(71) Applicant: LG ELECTRONICS INC., Seoul (KR)

(72) Inventors: Injun KIM, Seoul (KR); Dongjin SIM, Seoul (KR)

(73) Assignee: LG ELECTRONICS INC., Seoul (KR)

(21) Appl. No.: 14/690,187

(22) Filed: Apr. 17, 2015

(30) Foreign Application Priority Data
Jun. 19, 2014 (KR) 10-2014-0075119

(51) Int. Cl. G06F 3/041; G06F 3/0488; H04M 1/725

(52) U.S. Cl. CPC G06F 3/0416; H04M 1/72563; G06F 3/0488

(57) ABSTRACT

Provided is a mobile terminal including a display unit to which multiple images are output; a sensing unit that detects a touch gesture as being applied to a first image among the multiple images; and a controller that changes an output state of the first image based on the touch gesture. In a state where the output state of the first image is output, when at least one image is selected from among the multiple images, the controller performs control in such a way that at least one selected image overlaps the first image serving as a reference image, and sets the first image and at least one image that overlaps the first image serving as the reference image so that the first image and at least one image belong to a first group. Accordingly, the stored multiple images are quickly categorized on one screen without being moved to a different screen.

### CROSS-REFERENCE TO RELATED APPLICATION

Pursuant to 35 U.S.C. §119(a), this application claims the benefit of earlier filing date and right of priority to Korean Application No. 10-2014-0075119, filed on Jun. 19, 2014, the contents of which are hereby incorporated by reference herein in its entirety.

### BACKGROUND OF THE DISCLOSURE

1. Field of the Disclosure

The present disclosure relates to a mobile terminal capable of outputting multiple images and a method of controlling the mobile terminal.

2. Background of the Disclosure

In general, a terminal may be classified into a mobile (portable) terminal and a stationary terminal according to a moveable state. The mobile terminal may be also classified into a handheld terminal and a vehicle mount terminal according to a user's carriage method.

As functions of the terminal become more diversified, the terminal can support more complicated functions such as capturing images or video, reproducing music or video files, playing games and receiving broadcast signals. By comprehensively and collectively implementing such functions, the mobile terminal may be embodied in the form of a multimedia player or a device. Various attempts have been made to implement complicated functions in such a multimedia device by means of hardware or software.

In recent years, a camera built into a mobile terminal has been improved in terms of functions, and various types of high-capacity storage media have been available for use in the mobile terminal Thus, the user can store more images in the storage medium in the mobile terminal than before.

On the other hand, generally, the stored images are arranged within a specific folder in the chronological order in which the images were stored or captured. Then, it is possible that the images arranged within the specific folder in the chronological order are moved to a different folder through a user input and the like.

In the related art, at this time, the images that are intended to be moved to the different image are all selected at a time, but the folder within which the images are moved has to be selected one at a time. Accordingly, if the multiple images are arranged into the folders, inconvenience occurs in that the images and the folders have to be repeatedly selected. In addition, inconvenience occurs also in that in order to rearrange the one-time arranged images, the folder to which the images in question are moved is selected back and then the images in question are fetched.

### SUMMARY OF THE DISCLOSURE

Therefore, an aspect of the detailed description is to provide a mobile terminal capable of quickly arranging multiple images that are stored and a method of controlling the mobile terminal. To achieve these and other advantages and in accordance with the purpose of this specification, as embodied and broadly described herein, there is provided a mobile terminal including a display unit to which multiple images are output; a sensing unit that detects a touch gesture as being applied to a first image among the multiple images; and a controller that changes an output state of the first image based on the touch gesture.

In the mobile terminal, when at least one image is selected from among the multiple images, the controller may control the display unit in such a way that the selected image overlaps the first image serving as a reference image, and may set the first image and at least one image that overlaps the first image serving as the reference image so that the first image and at least one image belong to a first group.

In the mobile terminal, the touch gesture may be a touch gesture that starts from within the first image, moves out of the first image, draws a first line, and ends back within the first image, and in response to the touch gesture being detected as being applied, the controller may cause the first image to pop up in a manner that visually distinguishes the first image from the other multiple images.

In the mobile terminal, the first line may be a line that extends in a traverse direction from the first image, and when the touch gesture starting from within the first image is detected as being out of a reference range, the controller may output to the display unit an image object that guides a starting point and an ending point of the first line.

In the mobile terminal, when a predetermined input is received, the controller may generate a new folder of which a representative image is the first image, and may move the images that are set to belong to the first group from a current folder to the new folder.

In the mobile terminal, in a state where the first image pops up, when it is detected that the touch gesture starts from within a second image among the multiple images, moves out of the second image, draws the first line and ends back within the second image, the controller may cause the second image to pop up in a manner that visually distinguishes the second image from the first image and the other multiple images.

In the mobile terminal, in a state where the second image pops up, when at least one image is selected from among the multiple images, the controller may control the display unit in such a way that at least one of the selected image overlaps the second image that pops up, and may set the second image and at least one image that overlaps the second image serving as the reference image so that the second image and at least one image belong to a second group.

In the mobile terminal, in a state where the second group is set, when a first touch is detected as being applied to the first image that pops up, the controller may perform control in such a way that at least one image that is to be selected from among the multiple images overlaps back the first image serving the reference image.

In the mobile terminal, when multiple touches that are applied to points on the first image and the second image that pop up are detected as being dragged in one direction, the controller may combine the first group and a second group into one group, and may control the display unit in such a way that the first image and the second image overlap each other.

In the mobile terminal, the controller may output an icon for breaking up the group to one region of the first image that pops up, and when the touch is applied to the icon, the controller may control the display unit in such a way that the first image that pops up and at least one image that overlaps the first image serving as the reference image are moved to positions in which the first image and at least the one image are previously output, respectively.

In the mobile terminal, in a state where an output state of the first image is changed, in response to the touch starting from any one of the images in the same row of the multiple images ending in a different image, the controller may select at the same time the multiple images corresponding to a touch track, and may control the display unit in such a way that an indicator corresponding to the selection is displayed on the selected image.

In the mobile terminal, when a second touch is applied to the first image, the controller may perform control in such a way that at least one image that overlaps the first image serving the reference image is spread out on a predetermined region, and that displaying of at least the one spread-out image and of the multiple images other than the first image is inactivated.

In the mobile terminal, according to a drag touch input that is applied to at least the one spread-out image, the controller may move at least the one spread-out image along a direction in which at least the one spread-out image is dragged, and when at least the one spread-out image is selected from among at least the one or more spread-out images, the controller may perform control in such a way that different operations are executed according to a direction in which the selected image is dragged.

In the mobile terminal, when the first line is drawn on the first image, the controller may switch a screen in such a way that only the images that are set to belong to the first group are output, and when a second line is drawn on a screen that results from the screen switching, the controller may perform control in such a way that the resulting screen switches back to a previous screen.

In the mobile terminal, when the first line is drawn in a first direction on a control region that is defined between each of the multiple images, the controller may switch the screen to a state where the first group is broken up, and may output to one region of the display unit an icon for alerting a user that the first group is broken up.

In the mobile terminal, when the first line is drawn, in a second direction different from the first direction, on the control region that is defined between each of the multiple images on the screen that results from the screen switching, the controller may switch the screen back to a state where the first group is set and performs control in such a way that the icon disappear from the display unit.

In the mobile terminal, when the first line is drawn in a first direction on a predetermined region of the display unit, the controller may control the display unit in such a way that only the images that are not set to belong to the first group are output, and when the first line is drawn in a second direction different from the first direction on the predetermined region, the controller may switch the screen back to a state where the first group is set.

To achieve these and other advantages and in accordance with the purpose of this specification, as embodied and broadly described herein, there is provided a method of controlling a mobile terminal, including: outputting multiple images are output; detecting a touch gesture as being applied to a first image among the multiple images; changing an output state of the first image based on the touch gesture; controlling the display unit in such a way that the selected image overlaps the first image serving as a reference image, when at least one image is selected from among the multiple images; and setting the first image and at least one image that overlaps the first image serving as the reference image so that the first image and at least one image belong to a first group.

In the method, the touch gesture may be a touch gesture that starts from within the first image, moves out of the first image, draws a first line, and ends back within the first image, and the changing of the output state of the first image may be to cause the first image to pop up in a manner that visually distinguishes the first image from the other multiple images, based on the touch gesture.

The method may further include outputting to the display unit an image object that guides a starting point and an ending point of the first line, when the touch gesture starting from within the first image is detected as being out of a reference range, in which the first line may be a line that extends in a traverse direction from the first image.

The method may further include: detecting that the touch gesture starts from within a second image among the multiple images, moves out of the second image, and ends back within the second image; causing the second image to pop up in a manner that visually distinguishes the second image from the first image and the other multiple images; controlling a screen in such a way that when at least one image is selected from among the multiple images, at least the one selected image overlaps the second image serving as the reference image, which pops up; and performing control in such a way that when a first touch is detected as being applied to the first image, at least one image to be selected overlaps the first image serving as the reference image, which pops up.

According to the mobile terminal and the method of controlling the mobile terminal according to the embodiments of the present invention, the stored multiple images can be quickly categorized on one screen without being moved to a different screen. Accordingly, this saves the user from performing a process of categorizing the stored image into the same group.

In addition, the images that are categorized and the images that are not categorized are checked on one screen at the same time, and thus the user can categorize the stored images into different groups in an easier or intuitive manner.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of this specification, illustrate exemplary embodiments and together with the description serve to explain the principles of the disclosure.

In the drawings:

FIG. 1A is a block diagram illustrating a mobile terminal, described in the present specification, according to one embodiment;

FIGS. 1B and 1C are perspective diagrams illustrating the mobile terminal according to one embodiment of the present invention when viewed from different directions;

FIGS. 2(a), 2(b), 2(c) and 2(d) are diagrams for describing an exemplary method of controlling the mobile terminal according to the present invention;

FIG. 3 is a flowchart illustrating the method of controlling the mobile terminal according to the present invention;

FIGS. 4(a), 4(b), 4(c) and 4(d) are diagrams for describing a method of outputting a guide associated with setting of a group in the mobile terminal according to the present invention;

FIGS. 5A(a), 5A(b), 5B(a) and 5B(b) are diagrams for describing a method of selecting an image that is to be moved to a group that is set, in the mobile terminal according to the present invention;

FIGS. 5C(a) and 5C(b) are diagrams illustrating a method of breaking up the group that is set, in the mobile terminal according to the present invention;

FIGS. 6A(a), 6A(b), 6A(c), 6A(d), 6B(a), 6B(b), 6B(c), 6B(d), 7A(a), 7A(b), 7B(a), 7B(b), 7B(c) and 7B(d) are diagrams for describing methods of displaying on one screen the multiple groups that are set, in the mobile terminal according to the present invention;

FIGS. 8A(a) and 8A(b) are diagrams for describing a method of displaying the images included in the group that is set, in the mobile terminal according to the present invention;

FIGS. 8B(a) to 8B(b) and 8C(a), 8C(b), 8C(c) and 8C(d) are diagrams for methods of moving the images included in the group that is set, in the mobile terminal according to the present invention; and

FIGS. 9(a), 9(b), 9(c), 9(d), 10(a), 10(b), 10(c), 11(a), 11(b) and 11(c) are diagrams for describing methods of causing screen switching to the group that is set, in the mobile terminal according to the present invention.

### DETAILED DESCRIPTION OF THE DISCLOSURE

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

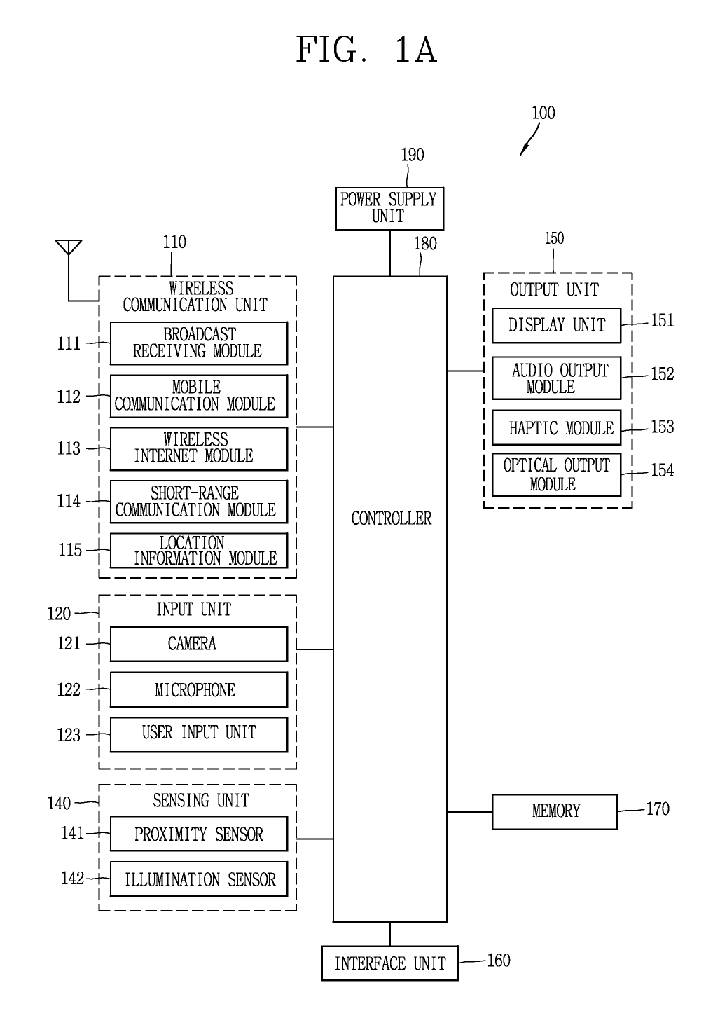

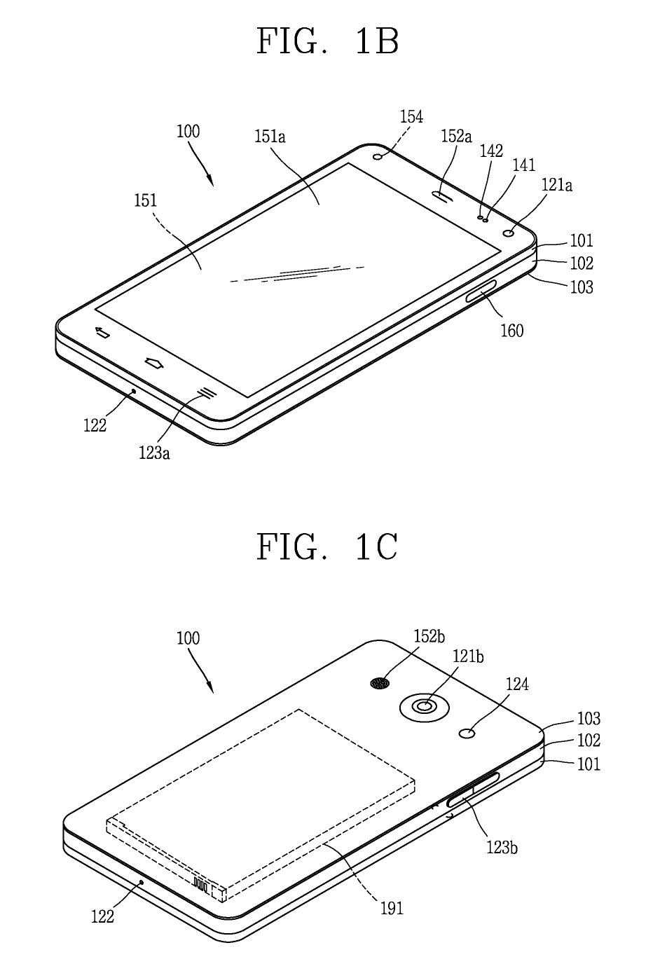

A mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components of FIG. 1A is not a requirement, and that greater or fewer components may alternatively be implemented.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), Wideband CDMA (WCDMA), High Speed Downlink Packet access (HSDPA), Long Term Evolution (LTE), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, GSM, CDMA, WCDMA, LTE and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the mobile terminal. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The display unit 151, the first audio output module 152a, the second audio output module 152b, the proximity sensor 141, the illumination sensor 142, the optical output module 154, a first camera 121a, a second camera 121b, the first manipulation unit 123a, the second manipulation unit 123b, the microphone 122, the interface 160, etc. may be provided at the mobile terminal 100.

As shown in FIGS. 1B and 1C, the display unit 151, the first audio output module 152a, the proximity sensor 141, the illumination sensor 142, the optical output module 154, the first camera 121a and the first manipulation unit 123a are arranged on a front surface of the terminal body. The second manipulation unit 123b, the microphone 122 and the interface 160 are arranged on side surfaces of the terminal body. And the second audio output module 152b and the second camera 121b are arranged on a rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable mobile terminals. Examples of such suitable mobile terminals include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two mobile terminals, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a receiver, and the second audio output module 152b may be implemented in the form of a loud speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may be implemented in a user's non-tactile manner, e.g., by a proximity touch, a hovering touch, etc.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (refer to FIG. 1A) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The mobile terminal 100 that has at least one or more configurations, among the configurations described above, according to an embodiment of the present invention, stores at least one image in predetermined storage space in the memory 160, based on a predetermined control command. At this time, in order to output the stored image, gallery application is executed according to the user input. When the gallery application is executed, thumbnails of the stored multiple images are output to the display unit 151. Then, based on a touch input that is applied to the thumbnail being output to the display unit 151, the controller 180 enlargedly outputs the selected thumbnail, or reduces the selected thumbnail to output more thumbnails.

In addition, based on a predetermined touch gesture being applied to the selected thumbnail, the mobile terminal 100 according to the embodiment of the present invention changes an output state of the selected thumbnail differently. In this manner, when the output state of the thumbnail is changed, a different thumbnail image to which the touch is applied thereafter is displayed on the thumbnail of which the output state is changed, in a manner that overlaps the output-state-changed thumbnail serving as the reference image. Then, the thumbnail images that overlap one another are set such that they belong to one group. Accordingly, the multiple images that are stored by the user are quickly categorized on one screen without being moved to a different screen.

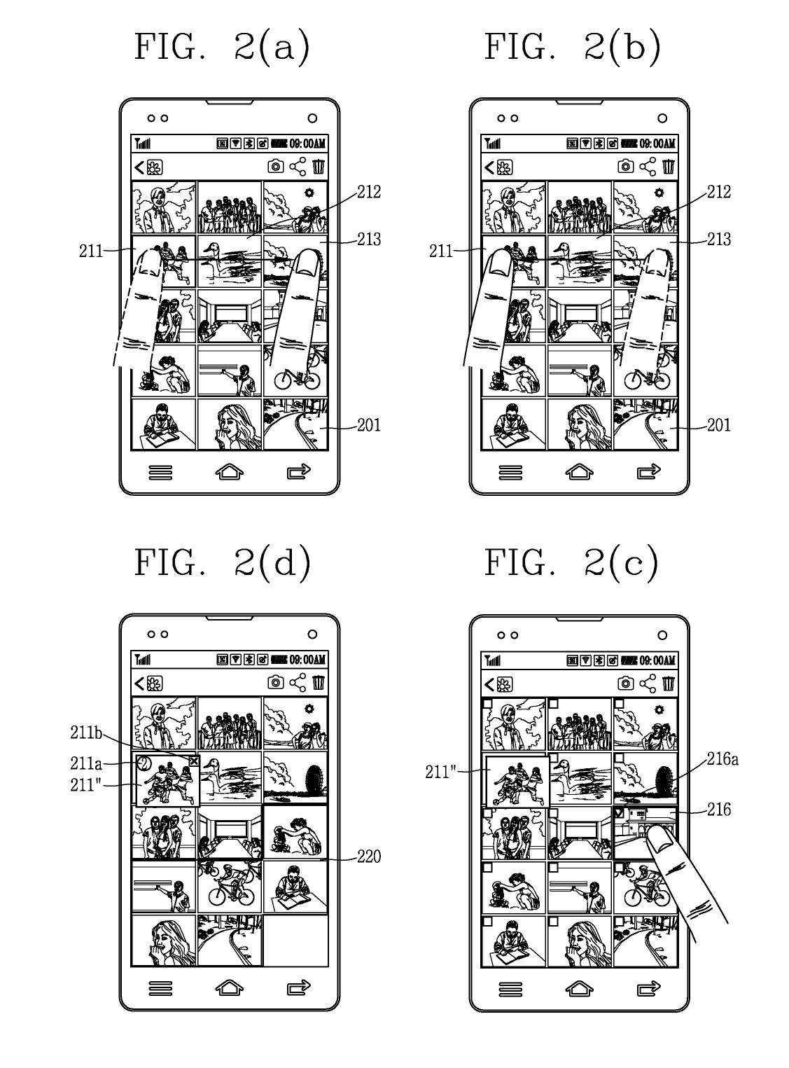

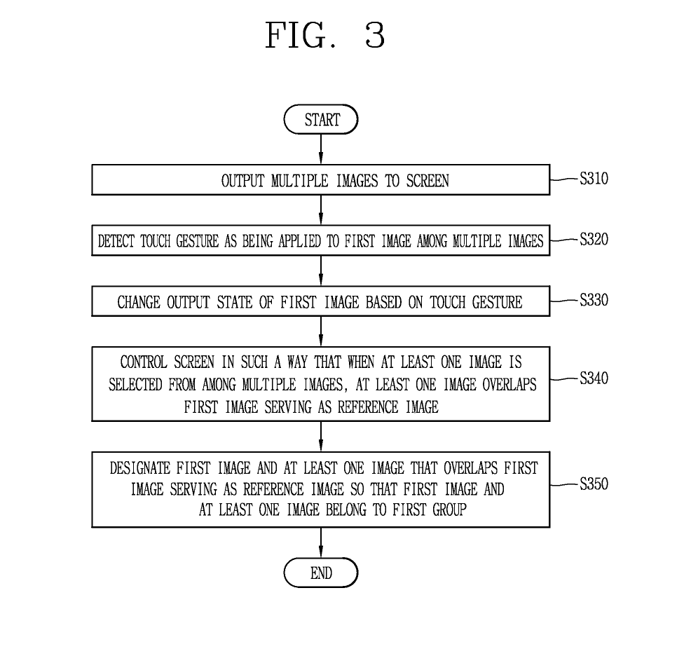

A method of categorizing the multiple images on one screen according to the embodiment of the present invention is described in more detail below referring to FIGS. 2(a) to 2(d) and 3.

First, referring to FIG. 3, the mobile terminal 100 according to the embodiment of the present invention outputs the multiple images to the display unit 151 (S310). For example, the mobile terminal 100 displays the stored multiple images on the display unit 151 according to the execution of the gallery application through the user input, or according to the application of a touch to a review screen after camera photographing.

At this time, there is no limit to types of the images being output to the display unit 151. For example, the images include an image that results from storing (capturing) screen information, as is, that is output to the display unit 151, and an image that results from storing only a photograph or a picture that is included in a webpage, one piece of screen information on a reproducible moving file, a picture file or wallpaper that is stored in a telecommunications carrier of the mobile terminal 100, an image that is downloaded from an external apparatus, and the like. In addition, the images are images that are displayed on the review screen after the camera photographing.

In this manner, in a state where the multiple images are output, the mobile terminal 100 detects the touch gesture that is applied to a specific image among the multiple images (S320).

At this point, the touch gesture means a touch gesture in which a touch starts from a specific image, moves out of a region to which the specific image is output, and ends back within the specific image. That is, the touch gesture mean a touch in which a touch starting point and a touch ending point are all positioned in the region to which the specific image are output.

Specifically, at this point, the example is described in which the touch starting from the specific image is dragged a long distance in a traverse direction, moves out of the specific image, is dragged back in the opposite direction, and ends within the specific image. This is done because a scroll operation can be executed on the images being output when the touch starting from the specific image is dragged in a traverse or diagonal direction. That is, if the touch applied to the display unit 151 moves upward or downward, there occur a problem that regardless of the user's intention to categorize the images, the images are moved upward or downward.

Accordingly, a configuration is realized in such a way that if the multiple images being output to the display unit 151 are scrolled in a vertical direction, only the touch gesture that is defined as being applied in a traverse direction is used, and if the multiple images are scrolled in a horizontal direction, only the gesture that is defined as being applied in a longitudinal direction is used. That is, the direction in which touch gesture is dragged is determined according to the direction in which the images being output can be scrolled.

On the other hand, if the user's intention is recognized in advance, and thus it is determined that the user's intention is to classify the images being output, not to scroll the images being output, the controller 180 performs control in such a way that a scroll function is locked. In such a case, the controller 180 performs control in such a way that the touch gesture to a specific image is applied without being limited to the vertical or vertical direction. That is, only when the touch starts from a specific image, moves out of the specific image and ends back within the specific image, the user is allowed to draw whatever shape (for example, a zigzag line, a heart, a circle, and the like) by a continuous line in a region out of the specific image.

In addition, the controller 180 determines which point the touch starting from a specific image is dragged (or slid) from the specific image to and then is dragged (or slid) back to the specific image from. Then, the controller 180, as described below, determines whether or not to change the output state of the specific image, depending on which point the touch starting from the specific image is dragged (or slid) from the specific image to and then is dragged (or slid) back to the specific image from.

To do this, the controller 180 sets a condition in which the touch is at least dragged from one end of an image that follows or precedes the specific image, to the other end. At this time, a direction in which the touch applied to the specific image is to be dragged is determined differently depending on an output position of the specific image. For example, if a specific image is displayed on the rightmost column of the display unit 151, the touch starting from the specific image is dragged, from right to left in a traverse direction, to an end of at least the preceding image. On the other hand, if the specific image is displayed on the leftmost column of the display unit 151, the touch starting from the specific image is dragged, from left to right in a traverse direction, to an end of at least the following image.

When such a touch gesture is detected as being applied to a specific image, the controller 180 recognizes the specific image as a trigger signal for categorizing (or gathering) other images with the specific image serving as the reference image. A specific image to which the touch gesture described above is detected as being applied is hereinafter referred to as a first image for description convenience.

For example, the sensing unit 140 of the mobile terminal 100 detects that the touch applied to a specific photographic image 211, as illustrated in FIG. 2(a), is dragged, in a traverse direction, on a screen 201 to which multiple photographic images are output, then extends from the specific image 211 to a region to which at least the following image 212 or the following images 212 and 213 are input, and then, as illustrated in FIG. 2(b), ends back within the same photographic image 211.

When such a touch gesture is detected, the controller 180 of the mobile terminal 100 changes the output state of the first image differently from the previous output state (S330).

At this point, changing the output state of the image means displaying the specific image to which the touch gesture is detected as being applied in a manner that distinguishes it visually from other multiple images. For example, a specific image to which the touch gesture is detected as being applied is displayed differently in size from other images, or is displayed on a region that distinguishes it from other images. Alternatively, a highlight effect is output to the specific image (for example a blinking effect, transparency changing effect, or a shadow effect is output to an edge of the specific image and the like). Alternatively, the specific image pops up or switches to a three-dimensional image.

FIG. 2(c) illustrates an example in which the specific photographic image 211, to which the touch gesture is detected as being applied, pops up. In this manner, when the photographic image 211 pops up, other multiple photographic images are displayed in a selectable state. That is, as illustrated in FIG. 2(c), an icon (for example, a box-shaped image) for selecting a photographic image is output to one region of each of the photographic images other than the photographic image that pops up, and thus the user is alerted to a state where the multiple photographic images are selectable.

In this manner, in a state where the output state of the first image is changed, when at least one among the multiple images, the controller 180 performs control in such a way that at least one image is displayed on the first image in a manner that overlaps the first image serving as the reference image (S340).

At this point, among the multiple images, at least one image is selected through a predetermined touch method, for example a short touch input. In addition, the multiple images may be selected sequentially one at a time, and may be all selected at a time.

In addition, at this point, at least one image overlapping the first image serving as the reference image means moving at least the one image to a region in which the first image is positioned and thus displaying the one image on the first image in a state where the one image is layered above or below the first image.

At this time, a representative image at the uppermost position is selected according to various references. For example, the multiple images are layered in such a way that the first image always stays at the uppermost position. In addition, for example, the multiple images are layered in such a manner a recently selected image stays at the uppermost position, that is, in a stack type structure.

In addition, the selection of the images to be categorized with the first image serving as a reference image is repeatedly made.

Specifically, each time at least one image is selected from among the multiple images, except for the first image, the controller 180 moves the selected image to a region to which the first image is output. Then, the following image is pulled forward to occupy the region on which the selected image is displayed. The controller 180 repeatedly performs this processing until a cancellation signal is input.

Referring to FIG. 2(c), when the touch is applied to a specific photographic image 216 among the selectable multiple images, an indicator (for example. ‘V’) alerting the user that the specific photographic image 215 is selected is output to an icon 216a. The selected photographic image 216 moves to a region in which a photographic image 211″ that pops up is positioned, and overlaps the photographic image 211″. Then, an icon 211a alerting the user to the number of the overlapping images, as illustrated in FIG. 2(d), is output to a first region (for example, an upper left region) of the image 211″ that pops up, and an execution icon 211b for canceling a pop-up state is output to a second region (for example, an upper right region) of the image 211″ that pops up.

Next, the controller 180 sets the first image and at least one image that overlaps the first image serving as the reference image such that they belong to the first group (S350).

One-time application of the touch to the images that are set in this manner so that they belong to the first group makes it possible to perform folder movement, folder position change, and folder deletion, and the like. In addition, the user can check whether the images are categorized into the first group or not categorized, and thus selects the images to be categorized next time.

In addition, in any one of Steps S330, S340, and S350, the controller 180 can set a new group, based on the touch applied to a specific image. In such a case, the images not categorized and the images categorized into the multiple groups are displayed on one screen in the same time. Accordingly, the user can check whether or not the multiple images are categorized into the multiple groups, or are not categorized, and thus selects the images to be categorized and the groups to which the images belong.

As described above, according to the embodiments of the present, the stored multiple images are quickly categorized on one screen without being moved to a different screen.

On the other hand, according to another embodiment of the present invention, there is no need to perform input operation on a separate menu key and the like in order to perform a control operation of categorizing the images. That is, as described above, a predetermined touch gesture is applied to the images being output, and thus the trigger signal is generated for categorizing the images.

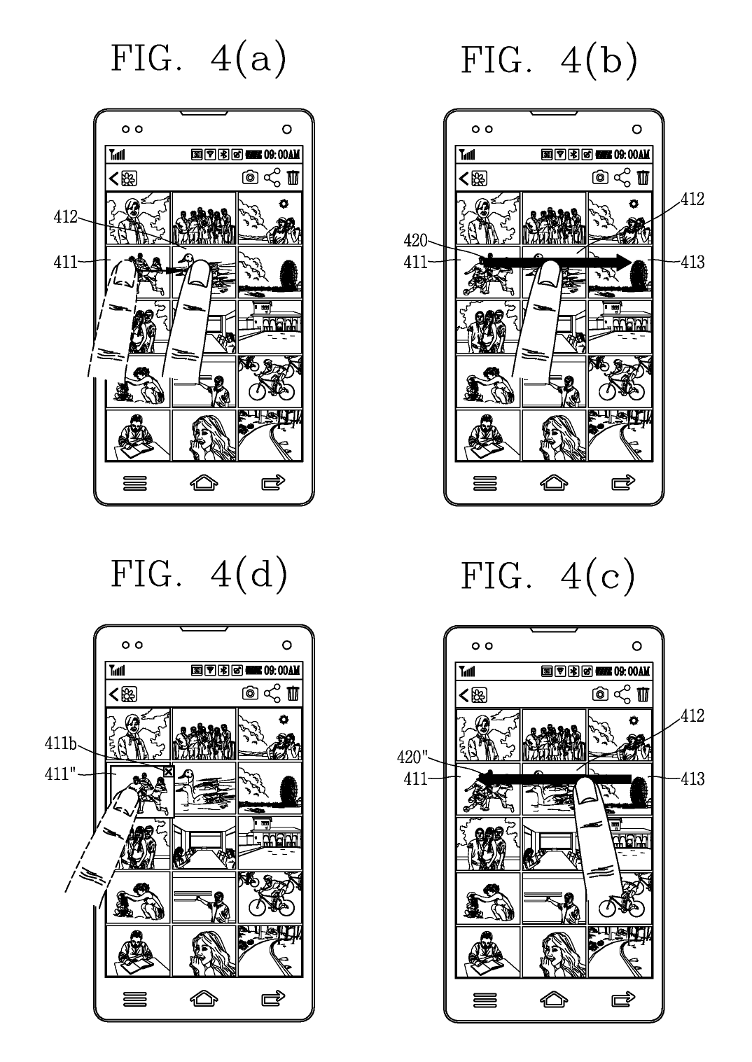

In this context, FIG. 4 is a diagram for describing generation of the trigger signal for categorizing the images and a method of outputting a guide for the generation of the trigger signal.

In a state where the multiple images are output to the display unit 151, when the touch gesture starts from within the first image, moves out of the first image, draws a first line and ends back within the first image, the trigger signal is generated for categorizing the images.

At this point, the first line means a line that extends, in a traverse direction, from the first image. At this time, a direction in which the first line extends, as described above, is determined depending on a position on which the first image is displayed.

In addition, the controller 180 determines which point the touch starting from a specific image is dragged (or slid) from the specific image to and then is dragged (or slid) back to the specific image from. Then, the controller 180, as described below, determines whether or not to change the output state of the specific image, depending on which point the touch starting from the specific image is dragged (or slid) from the specific image to and then is dragged (or slid) back to the specific image from.

To do this, the controller 180 sets the condition in which the touch is at least dragged from one end of an image that follows or precedes the specific image, to the other end. At this time, the direction in which the touch applied to the specific image is to be dragged is determined differently depending on the output position of the specific image. For example, a condition is set that if a specific image is displayed on the rightmost column of the display unit 151, the touch starting from the specific image is dragged, from right to left in a traverse direction, to an end of at least the previous image. On the other hand, a condition is set that if the specific image is displayed on the leftmost column of the display unit 151, the touch starting from the specific image is dragged, from left to right in a traverse direction, to an end of at least the following image.

Thereafter, when the dragged touch returns to within the specific image along a touch track, the controller 180 generates the trigger signal for categorizing the images. Then, a specific image is selected as the reference image for categorizing the images.

In addition, when it is detected that the touch gesture starting from within the first image moves out of a reference range, the controller 180 an image object, which indicates a starting point and an ending point of the first line, to display unit 151.

At this point, the image object may be an image that is displayed on each of the starting point and the ending point of the first line, and may be an image that extends from the starting point of the first line to the ending point. In addition, the image object may be a text alerting icon (for example, ‘Please continue dragging to the next image”) alerting the user to the starting point and the ending point of the first line.

At this time, when the dragging along the image object being output ends at the ending point of the first line, the controller 180 displays on the image object a point at which the first line turns and a direction in which the first line turns such that the touch gesture ends back within the first image. That is, the starting point and the ending point of the first line switches to the ending point and the starting point, respectively, and the resulting starting and ending points are displayed on the image object.

In response to the touch gesture being detected, the controller 180 causes the first image to pop up, in a manner that distinguishes it visually from other multiple images. The first image that pops up becomes a representative image of the first group for further categorizing other images.

For example, the touch applied to a specific photographic image 411 being output to the display unit 151, as illustrated in FIG. 4(a), is dragged in a traverse direction, and then enters into the following photographic image 412, an image object 420, as illustrated in FIG. 4(b), is output that alerts the user to a direction in which the drag extends and a point to which the drag extends. For example, the image object 420, as illustrated, an arrow-shaped image pointing in the rightward direction, which extends in a traverse direction from the selected first image 411. In addition, the image object 420 starts from within the first image 411 and ends in any one 413 among the images that follow the first image.

When the user performs the dragging along the image object 420 and finishes the dragging at the ending point positioned within the following image 413, an image object 420″ pointing in the opposite direction, as illustrated in FIG. 4(c), is output. The ending point of the first line is positioned within the first image 411 in such a way that the dragging along the image object 420″ pointing in the opposite direction ends back within the first image.

Subsequently, when the user extendedly drags the touch along the image object 413″ pointing in the opposite direction and ends the touch within the first image 411, the first image that pops up is displayed (411″). Then, an execution icon (for example, a mark “X”) 411b for canceling the popping-up is displayed on one region (for example, an upper right end) of the first image 411″ that pops up.

On the other hand, according to another embodiment, the image object is realized in shapes other than a straight line in the horizontal direction illustrated in FIGS. 4(a) to 4(d). For example, image objects in various shapes that can be drawn using one line of which starting point and ending points are positioned within the first image, such as a heart shape, a star shape, a circle, a rectangle, and a triangle, are output for guiding the dragging by the user (in this case, the drawn image object is displayed on the image that pops up. However, in this case, a function of scrolling images has to be locked at least until the dragging by the user ends.

When the first image pops up, the controller 180 categorizes the images, which are selected by using the touch, into the same group as the group to which the first image belong. Then, the selected image is displayed in a state where it overlaps the first image. The user repeatedly performs the selection of the images, and thus categorizes the multiple images into the first group.

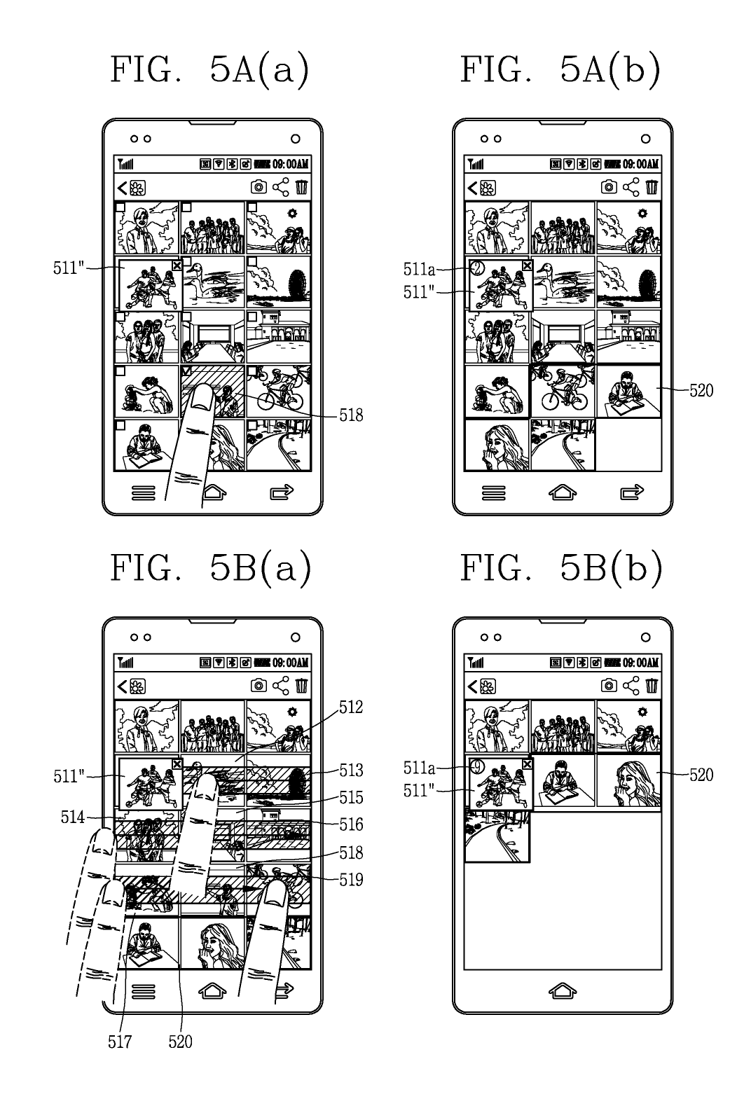

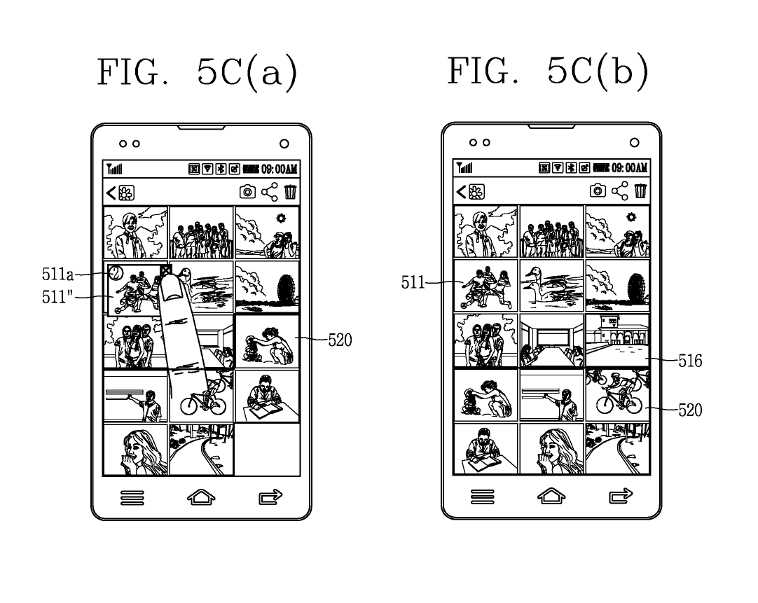

An example of selecting the images to be categorized is described in detail below referring to FIGS. 5A(a) to 5B(b).

Referring to FIGS. 5A(a) and 5A(b), when the first image 511″ pops up, the controller 180 outputs to each of other images an icon (for example, a box-shaped image) alerting the user that the image is selectable. When the user applies a predetermined touch (for example, a short-touch input) to a specific image 518, an indicator (for example, ‘V’) indicating that the specific image 518 is selected is output to an icon that is displayed on the specific image 518. At this time, when the user applies the touch to the image 518 successively, the selection is canceled. In addition, the user can select the multiple images by applying the touch to other images as well.

On the other hand, each time the selection is made, the controller 180 moves the selected image in such a way that the selected image overlaps the first image 511″. In addition, the controller 180 moves the images that are selected after selection operations are performed many times, in such a way that the selected images all overlap the first image 511 at a time. In the former case, in order to select the following image, the touch is repeatedly applied repeatedly to the first image 511″. In the latter case, a signal is input for moving the images that are selected by applying a successive different input (for example, a double short-touch input) to the image that is last selected, at a time to the first image 511″.

In either case, when the selected images are moved to the first image 511″, as illustrated in FIGS. 5A(a) to 5A(b), images 520 that follows the selected image 518 are pulled forward to occupy the regions to which the selected images 518 are output.

FIGS. 5B(a) to 5B(b) illustrate an example method of quickly selecting the multiple images.

Referring to FIG. 5B, in a state where the output state of the first image 511 is changed, that is, in a state where the first image 511″ that pops up is displayed, the controller 180 detects that a touch starting from any one of the images arranged in the same row among the images ends in another image.

When such a touch is detected, the controller 180 selects the multiple images corresponding to the touch track at the same time. In addition, the controller 180 displays an indicator responding to the selection on the selected image.

For example, when the touch starting from an A image 512 arranged in the same row ends in a B image 513, the A image 512 and the B image 513 are selected at the same time. Then, subsequently, when the touch starting from a C image 514 arranged in the following row ends in an E image 516, the C image 514, a D image 515, and the E image 516 are selected at the same time. Then, when the touch starting from an F image 517 in the following row ends in an H image 519, the F image 517, a G image 518, and the H image 519 are selected at the same time. At this time, as illustrated in FIG. 5B(a), an indicator corresponding to the touch track, for example, an shadow effect is output on the selected images on the display unit 151.

In addition, to quickly perform a selection operation, the controller 180 ignores a touch-up event that occurs between the rows. Then, when the selection operation in the last row is finally completed, the elected images are all moved at a time to the first image 511″. As a result, as illustrated in FIG. 5B(b), an icon 511a is displayed that indicates that a total of nine different images are included in the first image 511″ that pops up. The following images 520 that are not selected are rearranged to occupy the regions to which the selected images 512, 513, 514, 515, 516, 517, 518, and 519 are output.

Then, the controller 180 sets the first image 511″ and the images 512, 513, 514, 515, 516, 517, 518, and 519 that overlap the first image 511 serving as the reference image so that they belong to the same group. At this time, the images 511″, 512, 513, 514, 515, 516, 517, 518, and 519 that is set to belong to the same group are output in such a way that their size decreases in proportion to the number of the overlapping images in order for them not to hide other images that are not categorized.

In addition, when a predetermined input is received, the controller 180 generates a new folder of which a representative image is the first image and moves the images, which are set to belong to the first group, from a current folder to the new folder. At this point, the predetermined input, for example, results from pushing down a specific key provided to the mobile terminal or applying the touch to the display unit 151. When the predetermined input is detected, the controller 180 recognizes this as a control command for generating a new folder.

On the other hand, the controller 180 may store the images, which are categorized into the first group, to a different folder that is stored in advance.

FIGS. 5C(a) and 5C(b) illustrate one example of breaking up the group that is set to be on one screen.

AS illustrated in FIG. 5C(a), an icon for breaking up the group is output to one region (for example, an upper right region) of the first image that pops up. The icon, for example, is X-shaped.

When the touch is applied to the icon, the controller 180 moves the first image that pops up and at last one image that overlaps the first image serving as the reference image to theirs previous positions, respectively. That is, the group that is formed with the first image serving as the reference image is in a broken up state.

Accordingly, as illustrated in FIG. 5C(c), the image 516 that overlaps the first image 511 returns to its previous position, and the other images that are not categorized are rearranged based the positions of the first image 511 and the image 516.

On the other hand, according to the embodiment of the present invention, on one screen, categorization is performed while the images that are categorized and the images that are not categorized are checked at the same time. In addition, on one screen, the multiple images that are categorized into different groups are checked. Accordingly, while, at the same time, checking an A group and a B group on one screen, the user can selectively categorize the images that are not categorized into the A group or the B group.

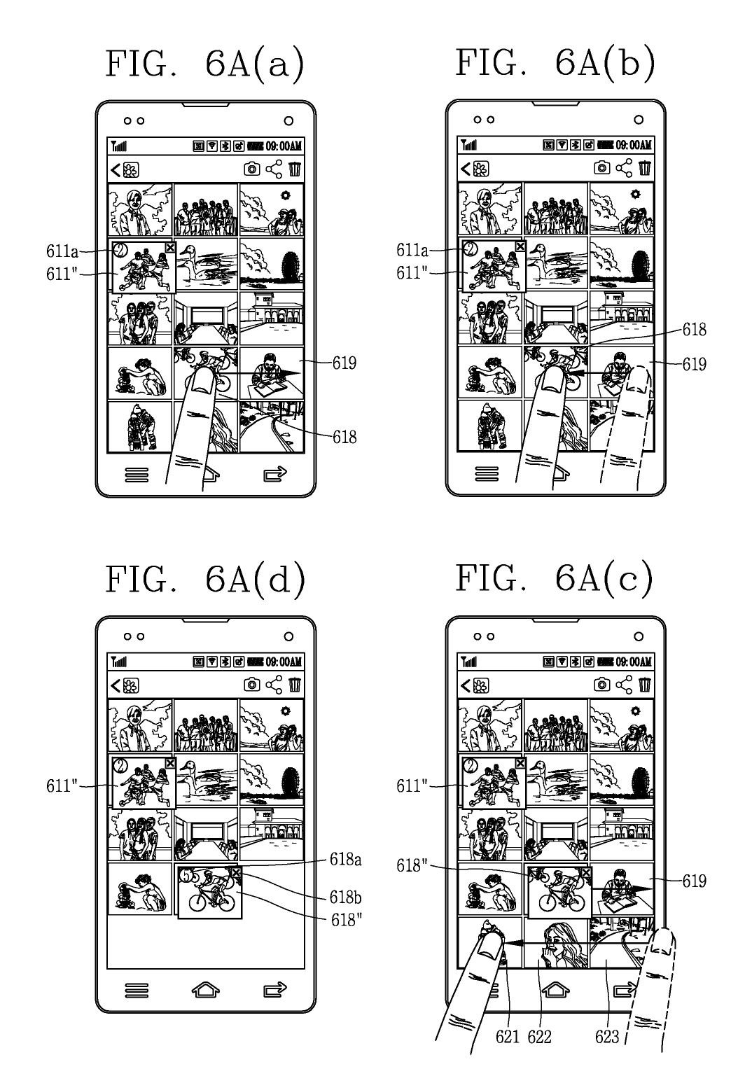

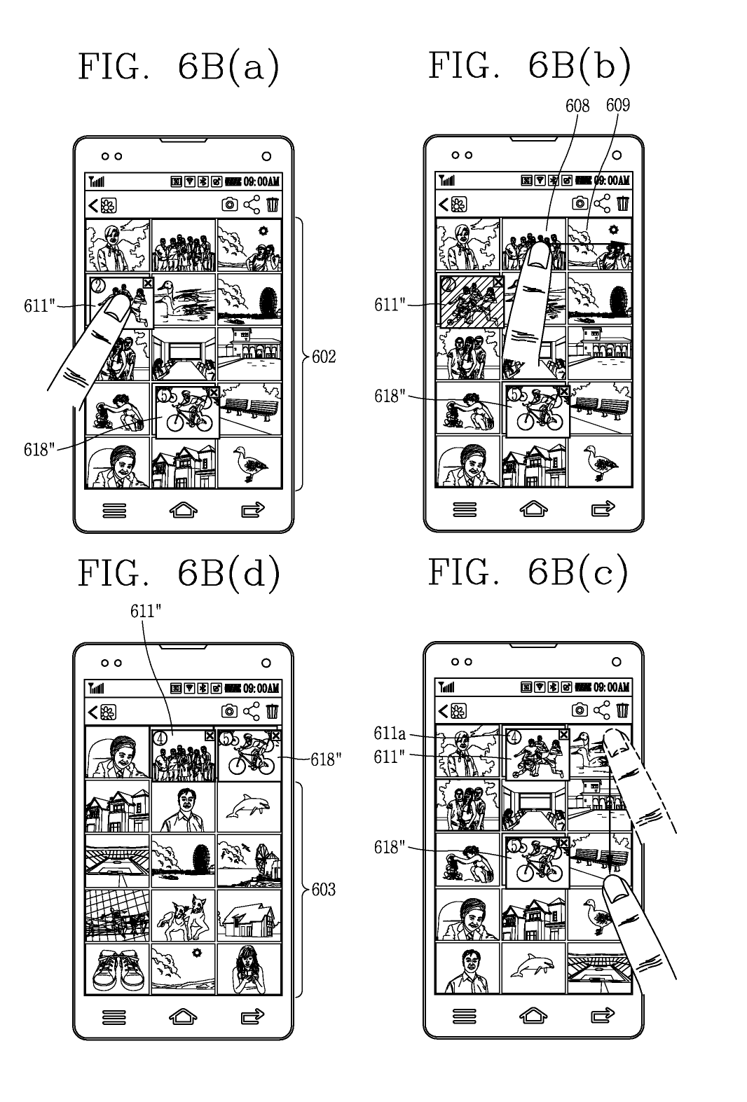

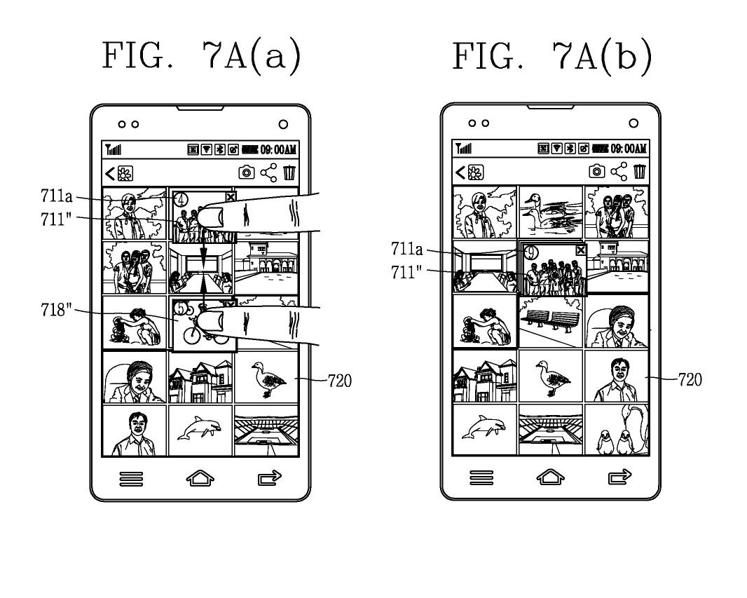

In this context, FIGS. 6A(a) to 6A(d), 6B(a) to 6B(d), 7A(a) to 7A(b), and 7B(a) to 7B(d) illustrate methods of displaying on one screen the multiple groups that are set.

Even though the first group is set, the controller 180 detects that the touch gesture starts from within any one (hereafter referred to as a “second image”) of the images that are output to the display unit 151, moves out of the second image, draws the first line, and ends back within the second image. Then, the controller 180 pops up the second image in a manner that distinguishes it visually from other multiple images and the first image.

At this point, the distinguishability of the second image through the popping-up means that the second image is displayed differently than the first image in terms of color, frame, background color, brightness, resolution, transparency, size and the like. In addition, the second image pops up in the shape different from that of the first image. In addition, an ordinal number (for example, “2” in the group 2) corresponding to the order in which the groups are set) is automatically displayed on the second image. In addition, in response to a predetermined touch input, for example, a long touch input being detected as being applied to the second image that pops up, text information that is distinguishable from the first image is directly into the second image.

In this manner, in a state where the second image pops up, when at least one image is selected from among other multiple images, the controller 180 moves at least the one image in such a way that at least the one image overlaps the second image serving the reference image, which pops up. Next, the controller 180 sets the second image that pops up and at least one image that overlaps the second image serving the reference image so that they belong to the second group.

For example, referring to FIGS. 6A(a) to 6A(d), in a state where a first image 611″ corresponding to the first group pops up, when the touch starting from a second image 618, as illustrated in FIGS. 6A(a) and 6A(b), is dragged all the way to the end of a following image 619, and ends back within the second image 618, a second image for alerting the user that another group, as illustrated in FIG. 6A(c), is set pops up (618″). Thereafter, the drag touch input is applied, in a traverse direction, to at least one images 619 or two or more 621, 622, and 623 that are positioned in a row, which are not categorized, the images 619, 621, 622, and 623 are selected along the touch track. Then, as illustrated in FIG. 6A(d), the selected images 619, 621, 622, and 623 are displayed in a manner that overlaps the second image 618″ serving as the reference image, which pops up, and an icon 618a for alerting the user to information on the number (for example, 5) of the categorized images is displayed on one region of the second image. Now, the second image and the images 619, 621, 622, and 623 that are displayed in a manner that overlap the second image are categorized into the second group.

In this manner, in a state where the second group is set, the controller 180 detects that the first touch is applied back to the first image that pops up. At this point, the first touch, for example, is the short-touch input that is applied to the first image. In this manner, the first touch is detected as being applied, the controller 180 performs control in such a way that at least one image, which is to be selected from among the multiple images that are not categorized, overlaps back the first image serving as the reference image.

For example, referring to FIG. 6B, in a state where the first image 611″ corresponding to the first group and the second image 618″ corresponding to the second group pop up on the display unit 151, if the user want to include in the first group at least one among the images that are not categorized, as illustrated in FIG. 6B(a), he/she applies the touch to the first image 611″ that pops up. Then, as illustrated in FIG. 6B(b), an indicator indicating that the group is selected, for example, a shadow effect is output to the first image 611″ that pops up.

Thereafter, when the user applies a touch and drag input to the images 608 and 609 that he/she wants to categorize into the same group as the group to which the first image 611″ belongs to, the selected images 608 and 609 overlap the first image 611″ serving as the reference image. At this time, as illustrated in FIGS. 6B(b) and 6B(c), if the selected images 608 and 609 are images that precede the first image 611″, the first image 611″ moves to regions on which the selected images 608 and 609 are displayed, to occupy such a region that is now in an empty state. Then, an icon 611a for alerting the user that a total of four images are categorized into the first group is displayed on the first image 611″.

On the other hand, scrolling is performed to search for many more images to categorize. For example, as illustrated in FIG. 6B(c), a flicking touch input is applied, and thus the photographic images that are output are scrolled downward. At this time, the first image and the second image that pop up are scrolled up to an upper end line (or are scrolled down to an lower end line) or maintain a pop-up state in their respective current position. As a result, as illustrated in FIG. 6B(d), the images that are not classified are scrolled and thus disappears from the display unit 151, and the first image 611″ corresponding to the first group and the second image 618″ corresponding to the second group continue to be displayed on the display unit 151. That is, the overlapping images that correspond to the group that is set remains displayed as if they floated over the display unit 151.

According to the embodiments of the present invention described above, the images that are categorized and the images that are not categorized are checked on one screen at the same time, and the stored images are categorized into different groups in an easier or intuitive manner.

On the other hand, when too many groups are displayed on one screen, displaying is complicated in terms of a relationship with other images that are not categorized and a malfunction occurs.

FIGS. 7A(a) to 7A(b) and 7B(a) to 7B(d) illustrate methods in which if many of the groups are to be displayed, the multiple groups can be accordingly displayed.

FIGS. 7A(a) and 7A(b) illustrates a method of combining multiple different groups into one group. As illustrated in FIG. 7A(a), the controller 180 detects that the multiple touches applied to the first image 711″ and the second image 718″ that pop up are dragged in one direction. At this point, the touch dragged in the one direction, for example, is a pinch-in touch input.

When the touch is detected as being applied in this manner, as illustrated in FIG. 7A(b), the controller 180 combines the first group and the second group into one group, and performs control in such a way that the first image 711″ and the second image 718″ that pop up overlap each other. At this point, the example is illustrated in which the image overlaps the first image 711″ serving as the reference image, but, the image may, of course, overlap the first image 718″ serving as the reference image. In addition, the group that results from the combination is displayed midway between the region on which the first image 711″ is displayed and the region on which the second image 718″ is displayed.

On the other hand, although not illustrated, when a pinch-out touch input is applied to the first image 711″ that belongs to the group that results from the combination in FIGS. 7A(a) to 7A(b), the group that results from the combination, as illustrated in FIG. 7A(a), is separated back into the first group and the second group, and thus the first group and the second group are displayed.

FIGS. 7B(a) to 7B(d) illustrates a method of displaying the multiple different groups on the display unit 151 in a manner that distinguishes between them.

The display unit 151 is divided into a first region (for example, a left side region) and a second region (for example a left side region). The images that are not categorized are output to the first region. The images that are categorized are output to the second region according to the groups to which they belong. At this point, a control operation that is applied to the first region is performed independently of the second region. That is, when a scroll signal is applied to the first region, only the images that are output to the first region are moved vertically, and the images that are displayed on the second region remains stationary.

If the number of groups 707″, 711″, 716″, and 718″ that are displayed on one screen, as illustrated in FIG. 7B(a), exceeds a predetermined positive integer (for example, 3), the controller 180, as illustrated in FIG. 7B(b), performs control in such a way that the display unit 151 is divided into the first region 151a and the second region 151b and thus the groups 707″, 711″, 716″ and 718″ are displayed on the second region 151b. That is, the photographic images that are not categorized are displayed on the first region 151a, and the groups 707″, 711″, 716″ and 718″ into each of which the photographic images are categorized are displayed on the second region 151b.

At this time, if the photographic image that is not categorized is intended to be categorized into the first group 707″, the touch, as illustrated in FIG. 7B(b), is once applied to the second region 151b and the images 701, 702, 703, 704, and 705 to be categorized into the first region 151a, as illustrated in FIG. 7B(c), are selected by the linear dragging. Then, as illustrated in FIG. 7B(d), the number of the images that belong to the first group 707″ is changed to 8 and thus is displayed (707a), and the selected images 701, 702, 703, 704, and 705 are moved from the first ion region 151a to the second region 151b.

On the other hand, the scroll signal that is applied to the first region 151a and the scroll signal that is applied to the second region 151b are independent of each other in terms of operation. That is, when the flicking touch input is applied to the second region 151b in the vertical direction, only the groups displayed on the second region 151b are moved in the vertical direction, and the images displayed on the first region 151a remains stationary.

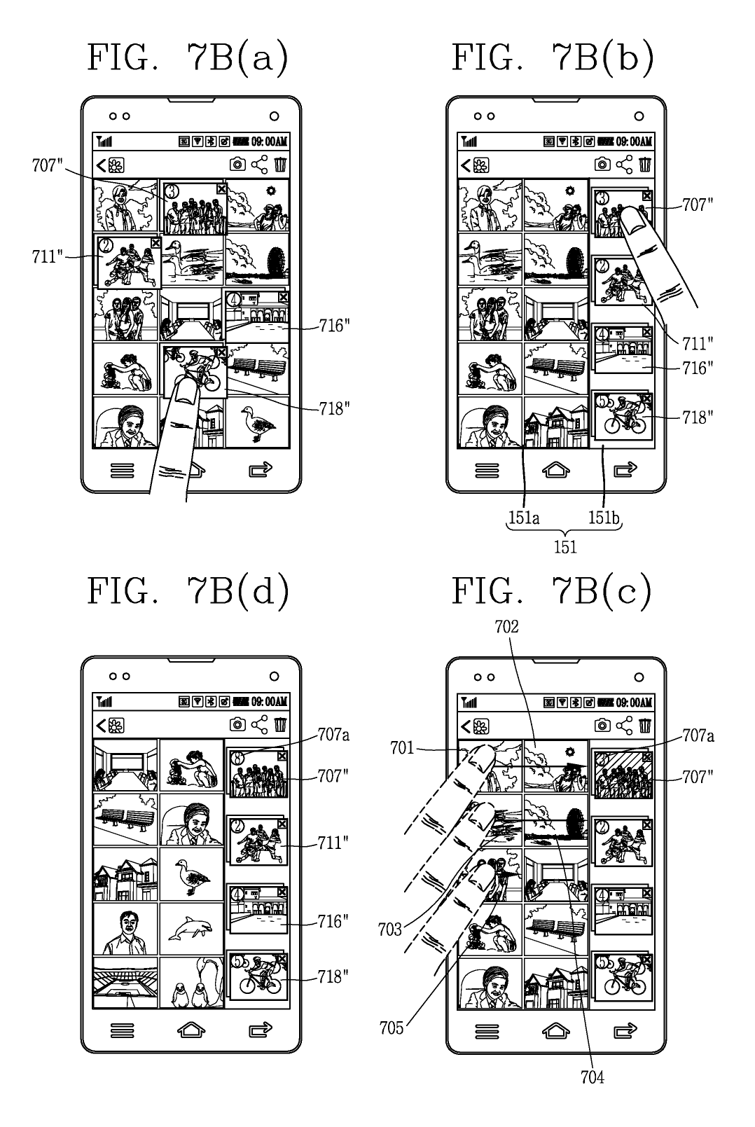

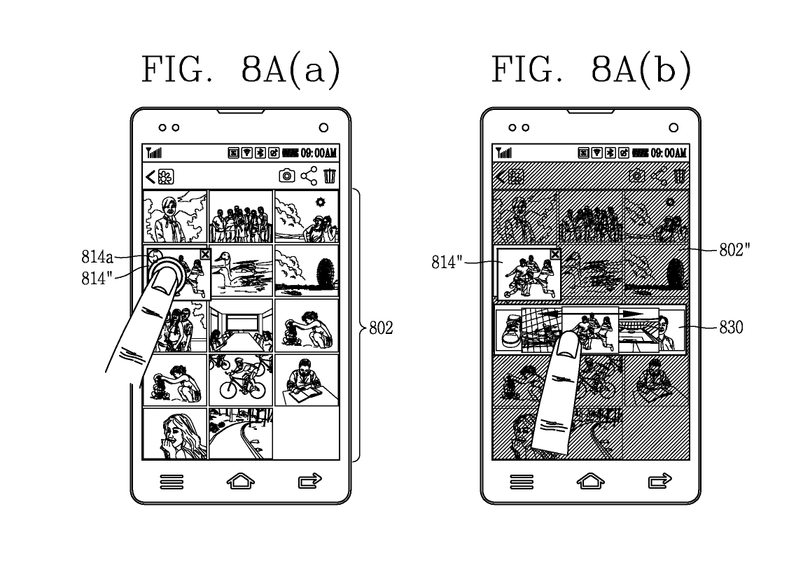

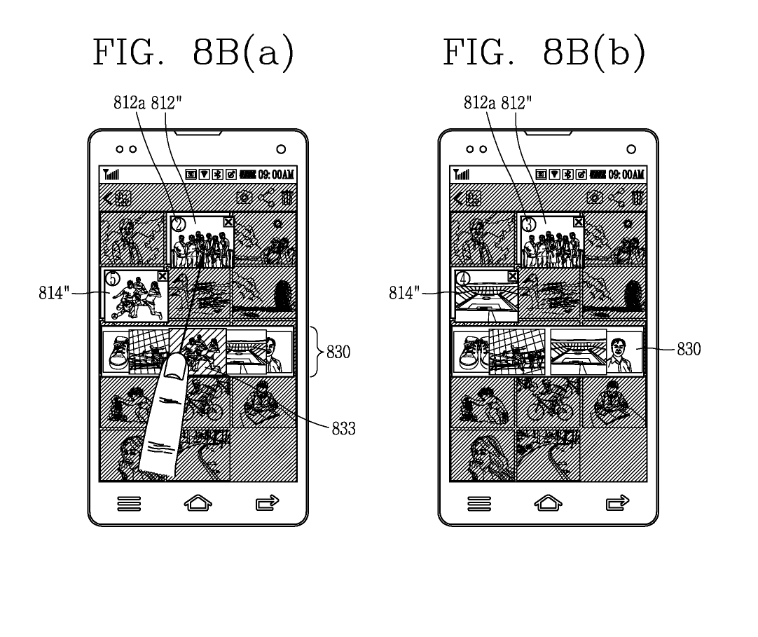

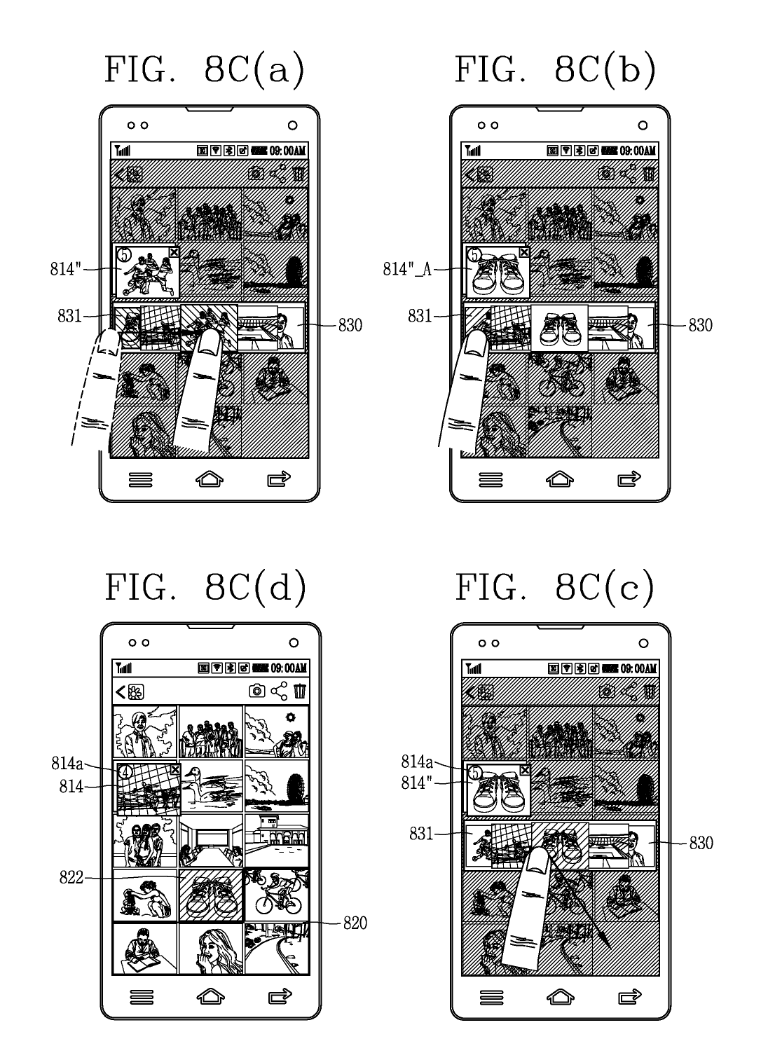

In addition, according to the embodiment of the present invention, it is possible that the images categorized into a specific group are checked immediately on one screen. In this context, FIGS. 8A(a) and 8A(b) illustrate a method of displaying the images that are included in the group that is set.

It is understood from FIG. 8A(a) that an icon 814a for alerting the user to the information on the number of the included images indicates that a total of five images, including the first image 814″ that pops up, are categorized into the same group. On the other hand, in some cases, the user wants to check again the four different images that overlap the first image 814″ serving as the reference image.

Accordingly, in response to the second touch (for example, the long-touch input) being applied to the first image 814″ that pops up, the controller 180 controls the display unit 151 in such a way that at least one image that overlaps the first image 814″ serving as the reference image is spread out on a predetermined region. For example, as illustrated in FIG. 8A(b), overlapping images 830 are output, in the form of a list, to a lower region of the first image 814″. However, the overlapping images are not limited to being output in the form of a list. The overlapping images 830 may be output separately to any other region of the display unit 151 or are output in such a way that instead of being spread out, the overlapping image may be turned over according to the touch gesture.

In this case, the controller 180 performs control in such a way that displaying of at least one image that is spread out and the multiple images (that is, images that are not categorized) other than the first image is inactivated. The images that are not categorized, of which the displaying is inactivated, is in a locked state in which inputting of the control command is limited. Therefore, according to the embodiment of the present invention, on one screen, the images are categorized, and in addition, all the images that are categorized are checked.

On the other hand, in this state, the controller 180 performs a control operation of moving the first image 814″ and at least one among the images 830 that are already categorized into the same group. In this context, FIGS. 8B and 8C are diagrams for methods of moving the images included in the group that is set, in the mobile terminal according to the present invention.

Specifically, according to the drag touch input that is applied to at least one spread-out image, the controller 180 moves at least the one spread-out image along a direction in which at least the one spread-out image is dragged. Accordingly, when at least one image is selected from among at least one or more spread-out images, the controller 180 performs control in such a way that different operations are executed according to the direction in which the selected image is dragged.

At this time, the control operation that is executed according to the direction in which the selected image is dragged is determined differently according to the output state of the image that corresponds to a point at which the drag ends. The output state of the image that corresponds to the point at which the drag ends is broadly categorized into (1) a state in which the image that is not categorized is output, (2) a state in which the image that belongs to the same group to the group to which the selected image belong is output, and (3) a state in which the image that belongs to a different group from the group to which the selected group belong is output.

FIGS. 8B(a) and 8B(b) illustrate an example of the control operation of moving to a different group at least one among the categorized images 830. That is, FIGS. 8B(a) and 8B(b) illustrate the control operation that is executed if the selected image is dragged to an image that belongs to a different group from the group to which the selected image belongs.

Referring to FIGS. 8B(a) and 8B(b), when the second touch is applied to the first image 814″ that pops up, the displaying of the images that are not categorized are inactivated, but the second image 812″ that pops up remains displayed. Next, the user can select a specific image 833 from among at least one or more images 830 that are spread out, and thus move the selected image 833 to the second image 812″ that pops up. That is, when the touch applied to the specific image 833 is dragged to the second image 812″, the image 833, as illustrated in FIG. 8B(b), is displayed in a manner that overlaps the second image 812″ that pops up. Accordingly, an icon 812a for alerting the user that there are a total of three images, including the added categorized image, is displayed on one region of the second image 812″ that pops up.

FIGS. 8C(a) to 8C(d) illustrate an example of the control operation in which at least one image, among the categorized images 830, moves within the group or is separated from the group. That is, FIG. 8C illustrates the control operation that is executed if the selected image is dragged to an image that belongs to a different group from the group to which the selected image belongs or if the selected image is dragged to an image that is not categorized.

FIG. 8C(a) illustrates a state where in response to the second touch (for example, the long-touch input) being applied to the first image 814″ that pops up, the images 830 is output that are categorized into the same group as the group to which the first image 814″ that pops up belong. The user can apply the touch to a specific image 831, among the spread-out images 830, and thus move the specific image 831 to any one among the spread-out images 830.

At this time, if the touch applied to the selected image 831 is released from the center point at which the first image 814″ among the spread-out images 830 is displayed, the first image 814″ that pops up is changed to the selected image 830. Accordingly, as illustrated in FIG. 8C(b), a representative image of the first group is changed to the selected image 831, and the images 830 are rearranged.

Next, as illustrated in FIG. 8C(c), if the image 831 is selected back from among the rearranged images 830, and thus is dragged out of the spread-out images 830, the image 831 moves from the spread-out images 830 to a region on which the image 831 was displayed before being categorized. Accordingly, as illustrated in FIG. 8C(d), the image 831 is displayed back on a region 822 on which the image 831 was previously displayed, and an icon indicating that the categorized image is separated from the first group is displayed on a first image 814 that pops up (814a). At this time, the representative image of the first group switches back to the representative image of the previous group, and the images that are not categorized, of which the displaying is inactivated, are back in an activated state.

On the other hand, in a state where the images that are not categorized, when the second touch (for example, the long-touch input) is applied back to the first image 814″ that pops up, at least one or more of the spread-out images 830 are displayed in a manner that overlaps the first image 814″ back, and the displaying of the images in an inactivated state, which are not categorized, is activated back.

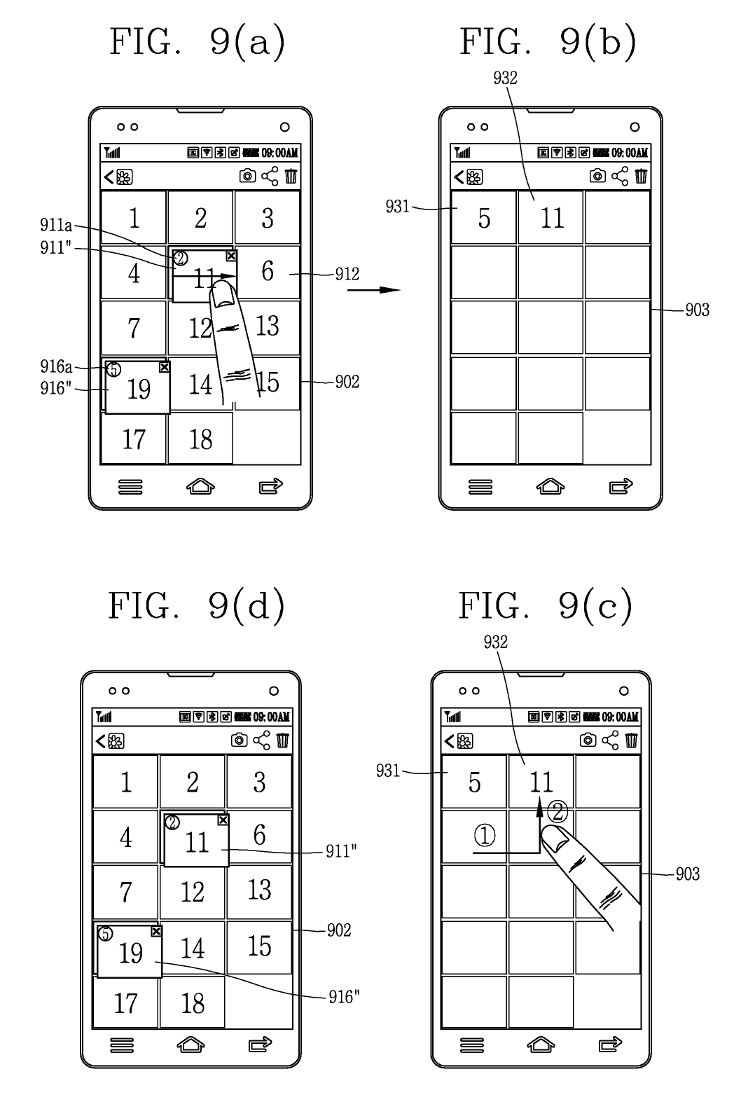

FIGS. 9(a) to 9(d), 10(a) to 10(c) and 11(a) to 11(c) are diagrams for describing methods of causing screen switching to the group that is set, in the mobile terminal according to the present invention.

As described above, according to the embodiment of the present invention, it is possible that while the images that are categorized and the images that are not categorized are checked on one screen, the image are categorized into one or more groups. On the other hand, if many groups into each of which the images are categorized are present, in some cases, the user wants to collectively view only the images that are categorized into the groups, or wants to collectively view only the images that are not categorized. In addition, in some cases, these operations are repeated.

An example of the control operation is described below in which a function of collectively viewing the images that belong to a specific group or a function of collectively viewing only the images that are not categorized is accordingly executed using the touch gesture in a traverse direction.

FIGS. 9(a) to 9(d) are diagrams illustrating the control operation of executing the function of collectively viewing the images that belong to a specific group. As illustrated in FIG. 9(a), in a state where a first image 911″ corresponding to the first group and a second image 916″ corresponding to the second group pop up on one screen, it is detected that the touch gesture (for example, the drag touch input) in along the first line that runs in a traverse direction is applied to the first image 911″. At this time, the first line may be drawn from left to right and from right to left.

In this manner, when the first line is drawn on the first image 911″, as illustrated in FIG. 9(b), the controller 180 switches the screen in such a way that only the images that belong to the first group corresponding to the first image 911″ are output. Accordingly, an image ‘1’ and an image ‘11’ that belong to the first group are output to the display unit 151. At this time, although not illustrated, an image indicating the first group is output to one region of the screen that results from the screen switching in this manner.

In this manner, in a state where the screen switching takes place in this manner, when the touch gesture along the first line that runs in a traverse direction, as illustrated in FIG. 9(c), is applied with being connected to the touch gesture along the second line that runs in a longitudinal direction, the previous screen, as illustrated in FIG. 9(d), is output back to the display unit 151. At this time, the touch gesture along the second line that runs in a traverse direction and the touch gesture along the first line that runs in a longitudinal direction are differently combined with each other. For example, a setting may be made in such a way that the screen switching to the previous screen takes place when the first line is drawn back on the display unit 151 in a state where the screen is displayed that results from the screen switching.

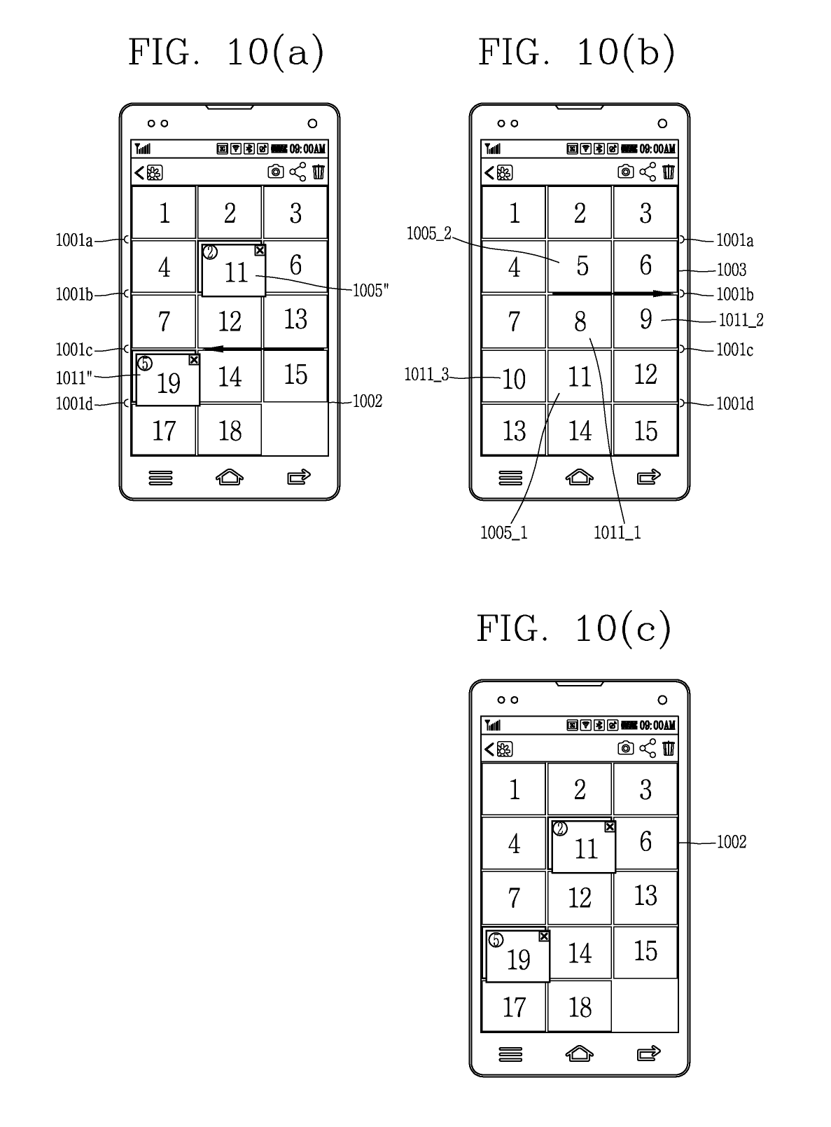

FIGS. 10(a) to 10(c) illustrate the control operation in which the state wherein the images are categorized is canceled and thus the function of collectively viewing all the stored images is executed.

As illustrated in FIG. 10(a), in a state where a first image 1005″ corresponding to the first group and a second image 1011″ corresponding to the second group pop up on one screen, the controller 180 detects that the first line is drawn, in a first direction, on a control region that is defined between each of the multiple images.

At this point, the control region that is defined between the multiple images, as illustrated in FIGS. 10(a) and 10(b), means a border region along a traverse line that is present between each of the images. Then, the first line is drawn by dragging the touch gesture on the border region in a traverse direction. A minimum length of the first line is defined in advance. For example, an extension of the drag from one end of the border region between at least two photographic images to the other end is defined as the first line. In addition, the first direction is defined as a direction in which the first line is dragged from one specific point (for example, one point on the right side) to another point (for example, another point the left side).

When the drag in a traverse direction, as illustrated in FIG. 10(a), extends from the right side end of a border region between images ‘12’ and ‘13’ and images ‘14’ and ‘15’ to the left side end of the border region, the screen switching to a state where all the groups that are set are broken up, as illustrated in FIG. 10(b), takes place. Accordingly, images 1005_1 and 1005_2 that are categorized into the first group, and images 1011_1, 1011_2, and 1011_3 that are categorized into the second group are displayed on the regions, respectively, on which they are previously displayed before being categorized. That is, all the stored images are displayed in the same state as they are before being categorized.

In this manner, when the screen switching takes place, the controller 180 outputs a predetermined icon for alerting the user that the group is broken up is output to one region of the display unit 151.

On the other hand, the controller 180 detects that the first line is drawn, in a second direction different from the first direction, back on the control region defined between each of the multiple images. The control region that is defined between each of the multiple images, as illustrated in FIGS. 10(a) and 10(b), means a border region in a traverse line that is present between each of the images. Then, the second direction means a direction from the ending point of the drag touch gesture in the first direction, which is applied before the screen switching takes place, to the starting point.

That is, when the drag in a traverse direction, as illustrated in FIG. 10B, extends from the left side end of a border region between images ‘5’ and ‘6’ and images ‘8’ and ‘9’ to the right side end of the border region, the screen switching to a state where images (an image ‘11’ and an image ‘19’) corresponding to the group that is set back pop up takes place.

Then, when the screen switching takes place in this manner, the controller 180 performs control in such a way that a predetermined icon for alerting the user that the group that is output to the display unit 151 is broken up disappears.

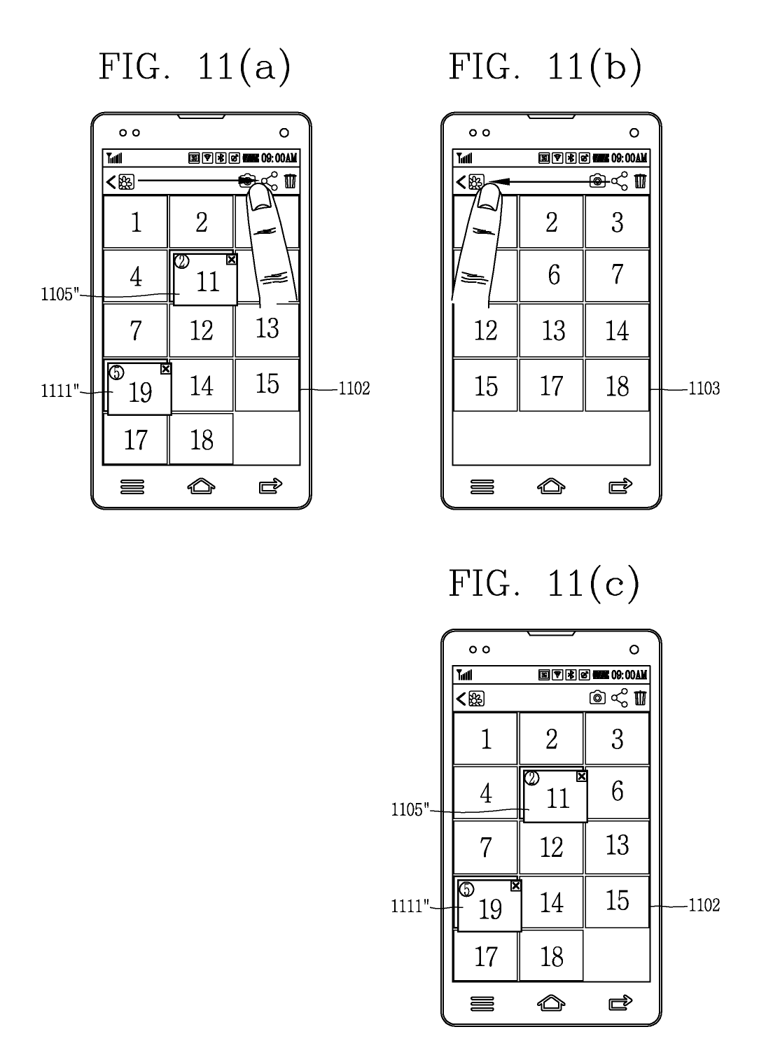

FIGS. 11(a) to 11(c) illustrate the control operation of executing the function of collectively viewing the images that are not categorized.

As illustrated in FIG. 11(a), in the state where a first image 1105″ corresponding to the first group and a second image 1111″ corresponding to the second group pop up on one screen, the controller 180 detects that the first line is drawn, in a first direction, on a predetermined region of the display unit 151.

At this point, the predetermined region of the display unit 151 is defined as a state display region to which state information on the mobile terminal is output as illustrated in FIG. 11(a). However, the predetermined region of the display unit 151 is not limited to this example. For example, the predetermined region of the display unit 151 may be defined as a region to which the image is not output. In addition, the first line in the first direction is defined as one that is drawn by dragging the touch gesture extending in a traverse direction from a specific point (for example, one point on the right side) to another point (for example, another point on the left side).

When the touch gesture is detected as being applied to a predetermined region, for example, the state display region of the display unit 151, the controller 180, as illustrated in FIG. 11(b), collects and outputs only the images that are categorized into the group. Accordingly, at least one image (for example, the image ‘11’) among the images that are categorized into the first group 1105″ and at least one image (the image ‘10’) among the image that are categorized into the second group 1111″ disappear from the display unit 151.

When in this state, the first line is drawn, in the second direction different from the first direction, the predetermined region, for example, the state display region of the display unit 151, the controller 180, as illustrated in FIG. 11(c), switches the screen back to the state in which the group is set.

As described above, the mobile terminal and the method of controlling the mobile terminal according to the embodiments of the present, the stored multiple images are quickly categorized on one screen without being moved to a different screen. Accordingly, this saves the user from performing a process of categorizing the stored image into the same group.

In addition, the images that are categorized and the images that are not categorized are checked on one screen at the same time, and thus the user can categorize the stored images into different groups in an easier or intuitive manner.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a touch screen; and
a controller configured to:
cause the touch screen to display a plurality of images;
change a display state of a first image among the plurality of images in response to a first touch input received at the first image such that the first image is indicated as a reference image;
move at least one other image among the plurality of images to the first image and cause the touch screen to display the first image and a portion of the at least one other image, in response to a second touch input received at the at least one other image, wherein the second touch input for selecting the at least one other image is received while the first image is indicated as the reference image, wherein the first image is overlapped with a portion of the selected at least one other image onto which the second touch input is applied; and
group the first image and the selected at least one other image to a first group.

2. The mobile terminal of claim 1, wherein:
the first touch input comprises a touch gesture that starts from within the first image, moves out of the first image, continues moving along a first line, and ends back within the first image; and
the controller is further configured to cause the touch screen to display the first image visually distinguishably from other images among the plurality of images in response to the touch gesture.

3. The mobile terminal of claim 2, wherein:
the first line extends from the first image in a horizontal direction; and
the controller is further configured to cause the touch screen to display an image object during the touch gesture to guide the touch gesture to an ending point of the first line when the touch gesture is progressed more than a threshold range.

4. The mobile terminal of claim 1, wherein:
the controller is further configured to generate a folder corresponding to the first group, the first image becoming a representative image for the folder such that the at least one other image is moved to the folder in response to the second touch input; and
the selected at least one other image is not displayed directly when the first image is overlapped with a portion of the selected at least one other image in the folder.

5. The mobile terminal of claim 2, wherein:
the controller is further configured to change a display state of a second image among the plurality of images in response to a second touch gesture that starts from within the second image, moves out of the second image, continues moving along a second line, and ends back within the second image; and
the second touch gesture is received while the first group is displayed.

6. The mobile terminal of claim 5, wherein the controller is further configured to:
move at least one image among the plurality of images to the second and cause the touch screen to display the second image and a portion of the at least one image, in response to an input for selecting the at least one image received while the second image is displayed in the changed display state, wherein the second image is overlapped with a portion of the selected at least one image onto which the input is applied; and
group the second image and the at least one image to a second group.

7. The mobile terminal of claim 6, wherein:
the controller is further configured to add an additional image among the plurality of images to the first group in response to a third touch input for selecting the additional image such that the first image, the at least one other image, wherein the first image is overlapped with a portion of the additional image of the first group; and
the third touch input is received while the first group and the second group are displayed, the third touch input received following a fourth touch input received at the first image representing the first group, the fourth touch input setting the first image as the reference image prior to receiving the third touch input.

8. The mobile terminal of claim 6, wherein the controller is further configured to:
combine the first group and the second group into one group in response to multiple touch inputs applied to a first point within the first image and a second point within the second image, the multiple touch inputs comprising dragging from the first point and the second point toward each other; and
cause the touch screen to display at least the first image and the second image to be overlapped with each other in the combined one group in response to the multiple touch inputs.

9. The mobile terminal of claim 1, wherein the controller is further configured to:
cause the touch screen to display an icon within the first image that is displayed in the changed display state, and
ungroup the first group and cause the touch screen to display the first image and the at least one other image at locations where the first image and the at least one other image were previously displayed prior to the grouping in response to a touch input received at the icon.

10. The mobile terminal of claim 1, wherein:
the controller is further configured to:
select multiple images on a same row among the plurality of images in response to a touch track received at the multiple images; and
cause the touch screen to display an indicator identifying the selected multiple images; and
the touch track is received while the first image is displayed in the changed display state, the touch track comprising successive touching of each of the multiple images.

11. The mobile terminal of claim 1, wherein the controller is further configured to cause the touch screen to:
display the first image and the at least one other image at a predetermined location of the touch screen in response to a third touch input received at the first image of the grouped first and at least one other images, the at least partially overlapped first image and at least one other image being spread out in response to the third touch input such that at least a portion of each of the spread-out first and at least one other images is visible; and
display the rest of the plurality of images other than the first image of the grouped images and the spread-out images on the background in response to the third touch input.

12. The mobile terminal of claim 11, wherein the controller is further configured to:
control the touch screen such that at least one of the spread-out images appears to move in a first direction in response to a drag touch input that is applied to the at least one of the spread-out images in the first direction; and
move the at least one of the spread-out images to a second group of images or delete the at least one of the spread-out images from the first group in response to a drag touch input that is applied to the at least one of the spread-out images in a second direction.

13. The mobile terminal of claim 1, wherein the controller is further configured to cause the touch screen to:
display only images belonging to the first group individually in response to a drag input received along a first line within the first image;
not display other images among the plurality of images in response to the drag input received along the first line within the first image;
redisplay the images belonging to the first group to be overlapped with each other in response to a drag input received along a second line while only the images belonging to the first group are displayed individually; and
redisplay the other images among the plurality of images in response to the drag input received along the second line.

14. The mobile terminal of claim 1, wherein the controller is further configured to cause the touch screen to:
display all images belonging to the first group individually in response to a first drag input received along a borderline between displayed images in a first direction; and
display an icon for indicating that the first group is ungrouped in response to the first drag input.

15. The mobile terminal of claim 14, wherein the controller is further configured to cause the touch screen to:
redisplay the first group such that the images belonging to the first group are displayed to be overlapped with each other in response to a second drag input received along a borderline between the displayed images belonging to the first group in a second direction; and
stop the displaying of the icon in response to the second drag input.

16. The mobile terminal of claim 1, wherein the controller is further configured to cause the touch screen to:
display a designated area for receiving a user input on a screen displaying the plurality of images including the first group;
display only images that do not belong to the first group in response to a first drag input applied in a first direction within the designated area; and
redisplay the plurality of images including the first group in response to a second drag input applied in a second direction within the designated area.

17. A method for controlling a mobile terminal, the method comprising:
displaying a plurality of images on a touch screen;
changing a display state of a first image among the plurality of images in response to a first touch input received at the first image such that the first image is indicated as a reference image;
moving at least one other image among the plurality of images to the first image and displaying the first image and a portion of the at least one other image, in response to a second touch input received at the at least one other image, wherein the second touch input for selecting the at least one other image is received while the first image is indicated as the reference image, wherein the first image is overlapped with the selected at least one other image onto which the second touch input is applied; and
grouping the first image and the at least one other image to a first group.

18. The method of claim 17, wherein:
the first touch input comprises a touch gesture that starts from within the first image, moves out of the first image, continues moving along a first line, and ends back within the first image; and
the first image is displayed visually distinguishably from other images among the plurality of images in response to the touch gesture.

19. The method of claim 18, further comprising:
displaying an image object during the touch gesture to guide the touch gesture to an ending point of the first line when the touch gesture is progressed more than a threshold range,
wherein the first line is a line that extends in a traverse direction from the first image.

20. The method of claim 19, further comprising:
changing a display state of a second image among the plurality of images in response to a second touch gesture that starts from within the second image, moves out of the second image, continues moving along a second line, and ends back within the second image, wherein the second touch gesture is received while the first group is displayed;
moving at least one image among the plurality of images to the second image and displaying the second image and a portion of the at least one image, in response to an input for selecting the at least one image received while the second image is displayed in the changed display state, wherein the second image is overlapped with the selected at least one image onto which the input is applied; and
grouping the second image and the at least one image to a second group.
